(19) United States
(12) Patent Application Publication
(10) Pub. No.: US 2025/0245701 A1
(43) Pub. Date: Jul. 31, 2025

(54) INFORMATION PROCESSING APPARATUS AND INFORMATION PROCESSING METHOD

(71) Applicant: Toshiba Tec Kabushiki Kaisha, Tokyo (JP)

(72) Inventor: Takashi ICHIKAWA, Tagata Shizuoka (JP)

(21) Appl. No.: 18/952,255

(22) Filed: Nov. 19, 2024

(30) Foreign Application Priority Data
Jan. 26, 2024 (JP) 2024-010479

(51) Int. Cl. G06Q 30/0241; G06Q 30/0251; G06V 40/16; G10L 13/08

(52) U.S. Cl. CPC G06Q 30/0276; G06Q 30/0255; G06Q 30/0269; G06V 40/172; G06V 40/174; G10L 13/08

(57) ABSTRACT

According to one embodiment, an information processing apparatus includes a processor and a camera interface connectable to a camera to receive camera images captured by the camera. The processor detects a feature of a customer of a store within a camera image, generates first text information corresponding to the detected feature of the customer, then inputs an inquiry text incorporating the first text information to a generative AI model to generate second text information for a promotion of a merchandise item sold at the store. The second text information can be sent to an output device in the store such as a display screen or a speaker.

### CROSS-REFERENCE TO RELATED APPLICATION

This application is based upon and claims the benefit of priority from Japanese Patent Application No. 2024-010479, filed Jan. 26, 2024, the entire contents of which are incorporated herein by reference.

### FIELD

Embodiments described herein relate generally to an information processing apparatus and an information processing method.

### BACKGROUND

In related art, generative AI (Artificial Intelligence) that can be used for generating texts, images, etc. has been attracting attention. Accuracy of the generative AI is increasing day by day. Promotional activities such as recommendations of merchandise items in response to a customer's inquiries have been performed by using the generative AI to provide text responses.

However, such promotional services using the generative AI are generally provided via a cloud-type computing environment. Accordingly, when information that is not desired to be output into the cloud, such as customer personal information is handled in such systems, the promotional service may be unavailable. Furthermore, the generative AI used in these promotional services provided in the cloud are not optimized to a particular store, and, as such, the purchase of a merchandise item not actually sold by the store may be recommended to a customer inadvertently.

### BRIEF DESCRIPTION OF THE DRAWINGS

FIG. 1 is a system chart showing an example of connection relations apparatuses in an information among processing system according to an embodiment.

FIG. 2 is a block diagram showing an example of a hardware configuration of a store computer.

FIG. 3 is a block diagram showing an example of functional aspects of a store computer.

FIG. 4 is a flowchart showing an example of processing executed by a store computer.

### DETAILED DESCRIPTION

A technological challenge solved by embodiments of the present disclosure is to improve information processing apparatuses and information processing methods to increase convenience of sales promotions provided to customers using generative AI.

In general, according to one embodiment, an information processing apparatus includes a camera interface connectable to a camera to receive camera images captured by the camera and a processor. The processor is configured to detect a feature of a customer of a store within a camera image, generate first text information indicating the detected feature of the customer, and then input an inquiry text, with the first text information added, to a generative AI to generate second text information for a promotion of a merchandise item. The processor is then configured to output the second text information to an output device in the store. The generative AI generates the second text information based on items sold in the store.

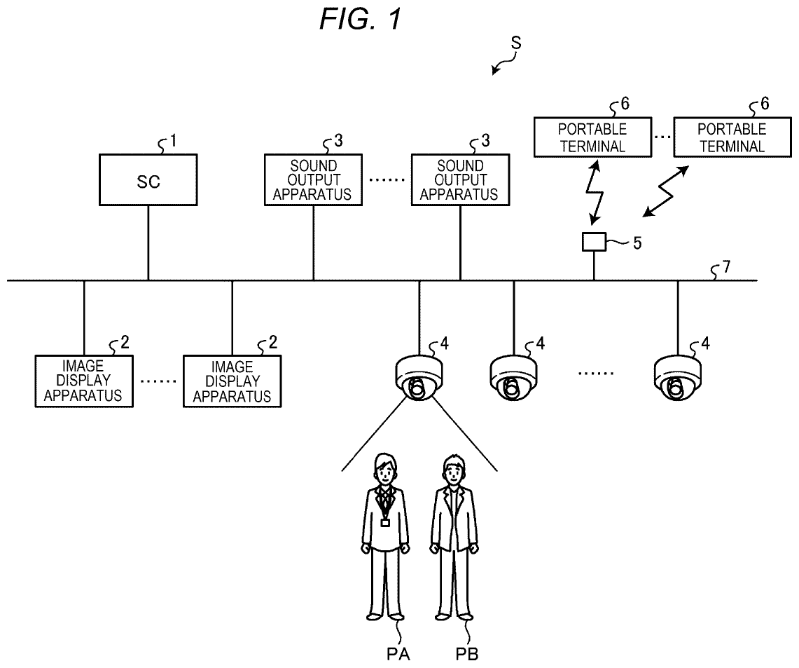

An information processing apparatus and an information processing method of certain example embodiments will be explained with reference to FIGS. 1 to 4. Note that, in the following embodiments, a store computer (SC) is installed in a store, such as a department store, a supermarket, or other facility, however, these examples do not limit the present disclosure.

FIG. 1 is a system chart showing an example of connection relations among respective apparatuses of an information processing system S according to the embodiment. In FIG. 1, the system includes a store computer (SC) 1, a plurality of image display apparatuses 2, a plurality of sound output apparatuses 3, a plurality of cameras 4, and a plurality of portable terminals 6.

The SC 1, the plurality of image display apparatuses 2, the plurality of sound output apparatuses 3, and the plurality of cameras 4 can be connected to one another via a communication line 7, e.g., a LAN (Local Area Network). The plurality of portable terminals 6 are connected to the SC 1 via an access point 5 or a repeater for wireless radio communication and the communication line 7.

Note that the respective numbers of the apparatuses shown in FIG. 1 are examples, and the information processing system S is not limited to the numbers specifically shown in FIG. 1. For example, the information processing system S may include a plurality of the access points 5.

The image display apparatus 2 displays a promotion image (promotional image or advertisement) for promoting a merchandise item being recommended to a customer for purchase. For example, the image display apparatus 2 is an information processing apparatus having a display device, such as a liquid crystal display or an organic EL (Electro Luminescence) display. Note that the image display apparatus 2 may be a display device itself or be connected to the display device.

For example, the image display apparatus 2 performs control to receive a promotion image (generated in the SC 1) from the SC 1 via the communication line 7 and displays the promotion image on the associated display device.

The sound output apparatus 3 outputs promotional sound (promotion sound) for promoting a merchandise item being recommended to a customer for purchase. For example, the sound output apparatus 3 is an information processing apparatus having a sound output device such as a speaker. Note that the sound output apparatus 3 may be the sound output device itself or connected to the sound output device.

For example, the sound output apparatus 3 performs control to receive a promotion sound (generated in the SC 1) from the SC 1 via the communication line 7 and outputs the promotion sound from the sound output device. The promotion sound may be an audio track including a voice speaking a promotional message or the like

The SC 1 generates promotion information (e.g., promotion images and promotion sound) to be provided to customers. For example, the SC 1 is a server apparatus. Note that the SC 1 may perform processing such as processing of collecting and managing merchandise sales registration information received from POS terminals. The SC 1 may include a single server apparatus or a plurality of server apparatuses.

For example, the SC 1 receives camera images obtained by the cameras 4 imaging the inside of the store from the cameras 4 via the communication line 7. Further, for example, the SC 1 receives reception results of radio waves constantly transmitted from a plurality of transmitters (e.g., radio wave transmitters for Bluetooth®, Wi-Fi, or the like) (provided within the store from the portable terminals 6.

For example, the SC 1 transmits the generated promotion image to the image display apparatus 2. Further, the SC 1 transmits the generated promotion sound to the sound output apparatus 3.

The cameras 4 capture images of people within the store. For example, a plurality of the cameras 4 are provided along aisles at fixed intervals on the ceiling or the like for imaging the people passing through the aisles of the store.

As an example, some of the cameras 4 monitor the store entrances and exits. In the example of FIG. 1, cameras 4 are provided along each of the aisles within the store and at least one of these cameras 4 acquires an image of a person PA (first person) and a person PB (second person). The images provided by the cameras 4 also contain information indicating imaging times (photo acquisition time) and imaging positions (e.g., position of the camera 4 providing the image).

In the present example, the portable terminals 6 are owned by the customers. The portable terminals 6 exchange various kinds of information with the SC 1. A portable terminal 6 is, for example, a smartphone, a tablet terminal, or the like. For example, the portable terminal 6 receives radio waves from the plurality of transmitters or beacons provided within the store. The portable terminal 6 transmits the reception result of the radio waves to the SC 1 via the access point 5 and the communication line 7.

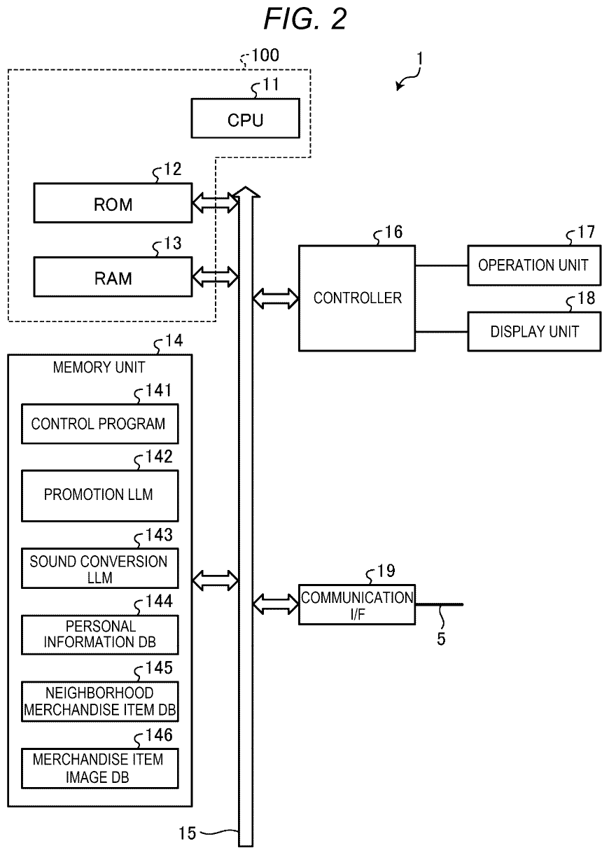

Next, a configuration of a SC 1 will be described. FIG. 2 is a block diagram of a SC 1.

As shown in FIG. 2, the SC 1 includes a CPU (Central Processing Unit) 11 as a main part for control, a ROM (Read Only Memory) 12 storing various programs, a RAM (Random Access Memory) 13 loading various kinds of data, a memory unit 14 storing various programs.

The CPU 11, the ROM 12, the RAM 13, and the memory unit 14 are connected to one another via a data bus 15. The CPU 11, the ROM 12, and the RAM 13 form a control unit 100. The control unit 100 executes various kinds of processing by the CPU 11 operating according to a control program 141 stored in the ROM 12 or the memory unit 14 and then loaded in the RAM 13.

Various programs such as the control program 141 can be loaded into the RAM 13. The RAM 13 also temporarily stores the images captured by the cameras 4 until these images are stored in the memory unit 14.

The memory unit 14 is a nonvolatile memory such as an HDD (Hard Disc Drive) or a flash memory that holds memory information if the power is shut down, and stores programs such as the control program 141. Furthermore, the memory unit 14 has stored therein a promotion LLM 142, a sound conversion LLM 143, a personal information DB 144, a neighborhood merchandise item DB 145, a merchandise item image DB 146.

The promotion LLM 142 is a generative AI for generating texts. The promotion LLM 142 is a so-called large language model (LLM). The promotion LLM 142 generates a recommended merchandise item text for presentation to a customer to encourage the customer to purchase a merchandise item. Note that, in the present embodiment, an LLM is used for the generative AI, however, the generative AI is not limited to LLMs and as long as the generative AI type can generate text it may be adopted.

The recommended merchandise item text is text mentioning a name of a merchandise item sold in the store and a content for a promotion of the merchandise item. Note that the recommended merchandise item text may be text in list form containing names of a plurality of merchandise items and corresponding content for promotions of each of the respective merchandise items.

For example, the promotion LLM 142 is an LLM constructed by a deep learning technique. The promotion LLM 142 receives text designating conditions, then outputs text related to merchandise items considered to be associated with or relevant to the designated conditions. Here, the conditions can be reference conditions for deriving output results or constraint conditions for narrowing down the output results.

The promotion LLM 142 generates a recommended merchandise item text according to the input of an inquiry text along with content indicating a customer position in the store (customer position information), customer attributes (customer attribute information), and/or customer personal information. In other examples, additional information may be supplied.

The sound conversion LLM 143 is generative AI generating text. The sound conversion LLM 143 is a large language model. The sound conversion LLM 143 generates a promotion sound text to be used as a basis of a promotion sound. For example, the promotion sound text is a script for a recommendation to purchase a merchandise item to be presented to the customer. Preferably, the promotion sound text corresponds well to a natural verbal explanation.

For example, the sound conversion LLM 143 is a LLM constructed by a deep learning technique. The sound conversion LLM 143 receives text related to merchandise items and provides promotional output for the merchandise items.

The sound conversion LLM 143 of the embodiment generates, in response to input of text data with addition of contents regarding the customer position information, the customer feature information, and the customer personal information to the merchandise item text, the promotion sound text.

The personal information DB (Data Base) 144 manages the customer personal information. For example, the personal information is customer information including an address, a name, an age, a sex, a customer ID, a telephone number, an E-mail address, a face image of the customer, information of a registered portable terminal, a purchase history of merchandise items in the store, and an output history of the recommended merchandise item texts.

As an example, the personal information DB 144 is a data base in which the address, the name, the age, the sex, the customer ID, the telephone number, the E-mail address, the face image of the customer, the identification information of the registered portable terminal (terminal ID), the purchase history of merchandise items in the store, and the history of the recommended merchandise item texts are correlated and stored with respect to each customer.

The neighborhood merchandise item DB 145 is a data base in which, for different specified positions within the store, the merchandise items near the position are listed. As an example, the neighborhood merchandise item DB 145 is a data base in which merchandise item information is correlated to the different specified positions within the store. Note that a plurality of pieces of merchandise item information may be correlated with each position. Similarly, the same merchandise item information m be correlated to different specified positions.

The merchandise item image DB 146 is a data base for management of merchandise item images. As an example, the merchandise item image DB 146 is a data base in which a merchandise item ID, a merchandise item name, and a merchandise item image are correlated with each merchandise item for sale at the store. Note that the merchandise item image may contain additional information such as text for presentation of the merchandise item. Or, the merchandise item image may include a plurality of images of a merchandise item from various angles or in different contexts.

An operation unit 17 and a display unit 18 are connected to the data bus 15 via a controller 16.

The operation unit 17 receives various kinds of input from an operator such as a store clerk. For example, the operation unit 17 includes a numeric keypad for inputting numerals and various functions keys.

The display unit 18 displays various kinds of information. For example, the display unit 18 may display images from the cameras 4. Or, the display unit 18 may display an image captured by a certain camera 4. Or, the display unit 18 may display multiple images captured by a plurality of cameras 4 on the same screen in split windows.

The data bus 15 connects to a communication I/F (Interface) 19 such as a LAN I/F. The communication I/F 19 is connected to the communication line 7.

The communication I/F 19 transmits and receives various kinds of information. For example, the communication I/F 19 receives images captured by the cameras 4 in real time.

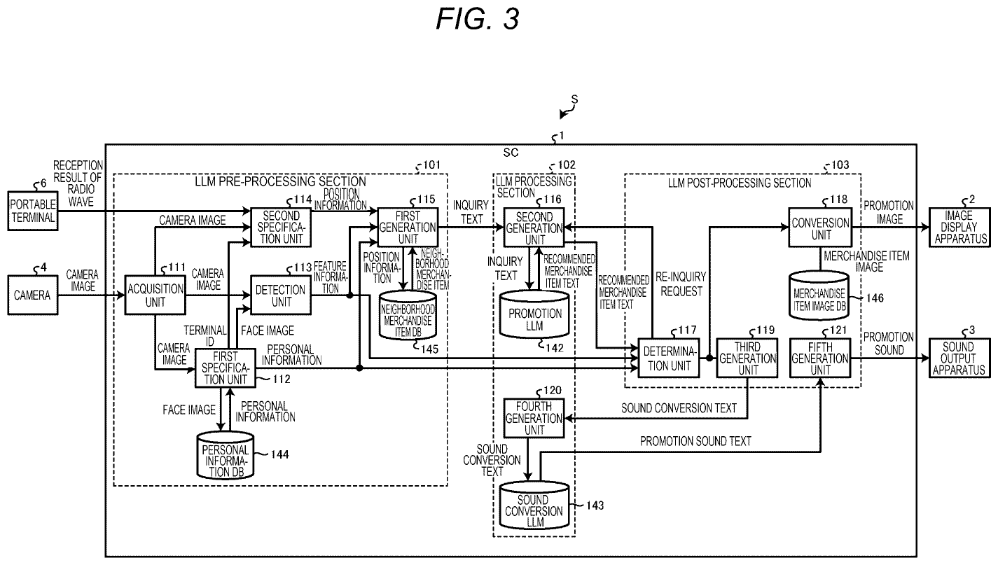

Next, certain functional aspects of the SC 1 will be explained. FIG. 3 is a functional block diagram showing an example of the functional aspects of the SC 1. The control unit 100 functions as an LLM pre-processing section 101, an LLM processing section 102, and an LLM post-processing section 103 according to various programs including the control program 141.

First, the LLM pre-processing section 101 is described. The LLM pre-processing section 101 performs LLM pre-processing. For example, the LLM pre-processing is a series of processes for generating promotion information using the promotion LLM 142. The LLM pre-processing makes the inputting of an inquiry text into the promotion LLM 142 feasible.

As shown in FIG. 3, the LLM pre-processing section 101 includes an acquisition unit 111, a first specification unit 112, a detection unit 113, a second specification unit 114, and a first generation unit 115.

The acquisition unit 111 acquires camera images from the cameras 4. For example, the acquisition unit 111 is a camera or video system interface that receives the camera images in real time via the communication line 7. The acquisition unit 111 sends the camera images to the first specification unit 112, the detection unit 113, and the second specification unit 114.

The first specification unit 112 identifies customer personal information. For example, the unit extracts a face image of a customer from an acquired image using a known image recognition technique. The first specification unit 112 may then provide an address, a name, an age, a sex, a customer ID, a telephone number, an E-mail address, a purchase history of merchandise items in the store, and an output history of the recommended merchandise item texts corresponding to the customer in the extracted face image. This information is referred to as customer personal information and can be obtained by reference to the personal information DB 144 stored in the memory unit 14.

The first specification unit 112 correlates the specified customer ID to the extracted face image and then sends out this correlated information to the detection unit 113. The first specification unit 112 also correlates the specified customer ID to the specified information for the registered portable terminal and sends out this correlated information to the second specification unit 114.

Furthermore, the first specification unit 112 correlates the specified customer ID to the specified personal information and sends this correlated information to the first generation unit 115 and a determination unit 117. Note that the personal information sent out to the first generation unit 115 and the determination unit 117 may be a subset of the available personal information. Similarly, the type or set of the personal information sent out to the first generation unit 115 and the determination unit 117 may be different.

Here, the first specification unit 112 provides a merchandise item purchase history of the customer in the store. The first specification unit 112 is an example of a second acquisition unit.

The detection unit 113 detects feature information of the customer appearing in the camera images. For example, the feature information is information related to an aspect of an appearance of the customer. Specifically, the feature information may be information indicating aspects of clothes the customer is wearing (e.g., customer is wearing a white sweater of Brand B and black pants of Brand C or the like). Note that the feature information may also or instead include information related to the present mood of the customer as estimated from the facial expression of the customer such as, e.g., delighted, angry, sad, or amused.

For example, the detection unit 113 identify the particular images including customer corresponding to the face image sent from the first specification unit 112 among the multiple camera images sent from the acquisition unit 111 to the detection unit 113. The detection unit 113 extracts the appearance features of the specified customer by an image recognition technique. The detection unit 113 correlates the extracted feature(s) as the customer feature information correlated to the customer ID and the face image sent from the first specification unit 112 and sends this information to the first generation unit 115 and the determination unit 117.

The second specification unit 114 identifies the customer position information. For example, the position information is information indicating a particular position of the customer within the store. For example, the second specification unit 114 receives indications of radio waves strength or other information related to positioning of the portable terminal 6 within the store. Here, the terminal ID of the portable terminal 6 is correlated with the indications of position provided by reception of the radio waves from each portable terminal 6.

For example, the second specification unit 114 checks the terminal ID correlated with the received radio waves and matches to the terminal ID sent from the first specification unit 112. For example, the second specification unit 114 identifies the position of the portable terminal 6 (identified by the terminal ID) from information representing a beacon location and intensity of radio wave received by the beacon from the portable terminal 6.

The second specification unit 114 then correlates the information representing the position of the portable terminal 6 to the customer ID (correlated with the terminal ID) as the customer position information and sends the information to the first generation unit 115 and the determination unit 117.

In this example, the customer position information sent to the first generation unit 115 and the determination unit 117 may contain information representing a radio wave reception time related to the position information (this radio wave reception time is also referred to as “position information time”). Thereby, the position of the customer at a particular time can be specified with the customer position information.

However, in some cases, a customer may not enter the store with a portable terminal 6, or the portable terminal 6 may not receive radio wave from the transmitter provided within the store for some reason. Accordingly, if the first specification unit 112 fails to identify a portable terminal 6 (or provide a terminal ID) for the customer or the accurate specification of positioning of the portable terminal 6 fails for some reason, the second specification unit 114 may provide the customer position information based on the camera images.

For example, if the acquisition of radio waves from a portable terminal 6 corresponding to the terminal ID sent from the first specification unit 112 fails, the second specification unit 114 sends the customer ID (correlated with the terminal ID) and issues a request to send the face image matching the customer ID to the first specification unit 112. The first specification unit 112 receiving the request correlates the customer ID with the face image and sends this information to the second specification unit 114.

The second specification unit 114 then searches the plurality of camera images sent from the acquisition unit 111 to identify a camera image including the customer matching the face image. The second specification unit 114 identifies the position of the customer based on an imaging position associated with the camera image including the customer.

Note that, if the customer appears in a plurality of camera images, the second specification unit 114 identifies the position of the customer using the latest (most recent) camera image based on an imaging time associated with in the camera image.

The first generation unit 115 generates an inquiry text based on the customer feature information. The inquiry text is instruction information (prompt) for the generative AI. The content of the output of the generative AI is based on the content of the prompt (instruction content). Hereinafter, the content of the prompt is also referred to as “instruction content”.

For example, the first generation unit 115 generates an inquiry text for the promotion LLM 142 to generate a text containing a merchandise item name and a promotion of the merchandise item. The recommended merchandise item is limited to a merchandise item sold in the store and is selected based on conditions associated with the processing results of the first specification unit 112, the detection unit 113, and the second specification unit 114.

Here, a template for generation of the prompt is stored in the memory unit 14 or the like. Note that a plurality of templates may be stored in the memory unit 14 or the like. In this case, the first generation unit 115 may select among the plurality of templates depending on the situation. For example, the first generation unit 115 may select the template according to a keyword contained in the inquiry text (e.g., a mention of a particular merchandise category (food, clothes, or the like)).

The first generation unit 115 then adds text based on the processing by the first specification unit 112, the detection unit 113, and/or the second specification unit 114 to the inquiry text according to the condition(s) designated by the instruction content.

For example, the first generation unit 115 adds information (text data) correlated with the customer ID as provided by the first specification unit 112, the detection unit 113, and the second specification unit 114 to the inquiry text. Here, information is correlated with the customer ID SO information from another customer may be prevented from being mixed into the inquiry text.

Specifically, the first generation unit 115 adds text data to the inquiry text containing description of the customer's position and description of the merchandise item(s) near the customer along with customer feature information, purchase history, and the output history of previous recommended merchandise item texts.

As an example, the first generation unit 115 adds text data “(customer name

“A”) IS IN FRONT OF SHELF IN LINGERIE SECTION” or the like as the description of the customer position information based on the customer personal information and the customer position information to the inquiry text.

The first generation unit 115 also specifies the merchandise item information corresponding to the customer position information by reference to the neighborhood merchandise item DB 145. In this case, the first generation unit 115 selects the neighborhood merchandise item in cooperation with the second specification unit 114, and the second specification unit 114 and the first generation unit 115 are examples of a second specification unit.

The first generation unit 115 adds text data of the name of the selected merchandise item in the neighborhood of the customer to the inquiry text.

The first generation unit 115 also adds text data “WEARING WHITE SWEATER OF BRAND B AND BLACK PANTS OF BRAND C” or the like as description of the customer feature information based on the customer personal information and the customer feature information to the inquiry text.

The first generation unit 115 also adds text data “CUSTOMER A PURCHASED SHIRT WITH MERCHANDISE ITEM CODE XX ON MM/DD” as the description of the purchase history of the to the inquiry text.

The inquiry text thus contains the description of the purchase history of the merchandise items by the customer and an instruction not to repeat the purchased merchandise item such that the situation that a merchandise item already purchased by the customer will be recommended to the customer may be avoided or suppressed.

The first generation unit 115 also adds text data “PURCHASE OF SHIRT WITH MERCHANDISE ITEM CODE YY HAS BEEN RECOMMENDED TO CUSTOMER A AT D TIMES IN THE PAST” or the like as the description of the output history of the recommended merchandise item texts.

The inquiry text contains the description of the output history of the recommended merchandise item texts and an instruction not to select a merchandise item that was previously recommended at a predetermined number of times in the past without purchase such that a merchandise item will not be repeatedly recommended again beyond the point it seems apparent the customer is not interested in the item (a merchandise item considered to be of low interest to the customer).

The first generation unit 115 correlates the generated inquiry text with the customer ID and sends to a second generation unit 116. Here, the inquiry text contains a position information time based on the generated inquiry text time (hereinafter, also referred to as “inquiry time”).

Next, the LLM processing section 102 executes LLM processing. In this context, the LLM processing is processing of inputting an inquiry text (prompt) to the LLM and acquiring a text response output from the LLM. As shown in FIG. 3, the LLM processing section 102 includes the second generation unit 116 and a fourth generation unit 120.

The second generation unit 116 provides (generates) a recommended merchandise item text from the inquiry text. The recommended merchandise item text is an example of second text information. For example, the second generation unit 116 inputs the inquiry text sent from the first generation unit 115 to the promotion LLM 142 stored in the memory unit 14. The second generation unit 116 acquires the text data output from the promotion LLM 142 as the recommended merchandise item text.

Further, the second generation unit 116 sends the acquired recommended merchandise item text to the determination unit 117. Here, the recommended merchandise item text out to the determination unit 117 contains the inquiry time of the inquiry text.

Furthermore, the second generation unit 116 specifies an output history of the recommended merchandise item texts corresponding to the customer ID associated with the inquiry text by reference to the personal information DB 144. The second generation unit 116 performs processing of adding the acquired recommended merchandise item text to the specified output history of the recommended merchandise item texts.

Note that the second generation unit 116 may execute part or all of the above described processing of the first generation unit 115. Further, the first generation unit 115 may execute part or all of the processing of the second generation unit 116.

Next, the LLM post-processing section 103 performs LLM post-processing. In this example, the LLM post-processing is processing performed on the recommended merchandise item text as generated by the second generation unit 116 (promotion LLM 142).

As shown in FIG. 3, the LLM post-processing section 103 includes the determination unit 117, a conversion unit 118, a third generation unit 119, a fifth generation unit 121, and an output control unit 122.

The determination unit 117 performs a determination regarding the output of the promotion information. For example, the determination unit 117 determines whether or not the promotion information is to be output based on the customer position information sent out from the second specification unit 114. As an example, the determination unit 117 determines that the promotion information is to be output if the customer position information does not change over some predetermined amount of time.

Note that the determination unit 117 may determine a change of customer position by regarding any movement within a predetermined range (e.g., a movement within a radius of E meters from the initial the customer position information) as standing still.

Further, if the determination unit 117 determines that the promotion information is to be output, the unit determines whether or not a re-inquiry is necessary. For example, the determination unit 117 compares the latest customer position information with customer position information at the inquiry time and, if the positions are the same, determines that a re-inquiry is unnecessary but, if the positions are not the same, determines that a re-inquiry is necessary.

Note that the determination unit 117 may regard positions as being the same within a predetermined range (e.g., the change of the customer position information within a radius of E meters).

If the determination unit 117 determines that a re-inquiry is necessary, the unit sends out a re-inquiry request to the first generation unit 115. If the determination unit 117 determines that the promotion information is not to be output for any reason, a re-inquiry request like the above may be output. The first generation unit 115 receives the re-inquiry request then generates and sends another inquiry text to the second generation unit 116 based on the latest position information, feature information, and personal information.

If the determination unit 117 determines that the promotion information is to be output (and thus determines that a re-inquiry is unnecessary), an output destination for the promotion information is determined. For example, the determination unit 117 specifies the image display apparatus 2 or the sound output apparatus 3 closest to the latest customer position information.

The determination unit 117 may selected between an image display apparatus 2 or sound output apparatus 3 as an output destination of the promotion information based on whether or not the apparatus is within a predetermined range of the latest customer position information. If multiple apparatuses are present within the predetermined range, the determination unit 117 may select multiple apparatuses as an output destination of the promotion information.

If the output destination is an image display apparatus 2, the determination unit 117 sends the recommended merchandise item text (from the second generation unit 116) to the conversion unit 118. Here, the recommended merchandise item text is correlated with information for display on the image display apparatus 2 and converted to “image display apparatus information” as appropriate.

If output destination is a sound output apparatus 3, the determination unit 117 sends the recommended merchandise item text (from the second generation unit 116) to the third generation unit 119. Here, the recommended merchandise item text is correlated with information for output from the sound output apparatus 3 and converted to “sound output apparatus information” as appropriate.

The recommended merchandise item text sent to the third generation unit 119 can be correlated with the customer personal information, feature information, and position information corresponding to the recommended merchandise item text.

Note that the determination unit 117 may select both or either of the image display apparatus 2 and the sound output apparatus 3 closest to the latest customer position information as the output destinations regardless of the distance from the latest customer position information.

The conversion unit 118 converts the recommended merchandise item text into a promotion image containing a merchandise item image of the recommended merchandise item. The conversion unit 118 is an example of a third generation unit.

For example, the conversion unit 118 specifies a merchandise item image corresponding to the name of the merchandise item contained in the recommended merchandise item text sent from the determination unit 117 by reference to the merchandise item image DB 146. The conversion unit 118 converts the recommended merchandise item text into the specified merchandise item image. Then, the conversion unit 118 places the converted merchandise item image into a predetermined screen template or the like and generates a promotion image for display.

Further, the conversion unit 118 correlates the image display apparatus information with the generated promotion image and sends the information to the output control unit 122.

The third generation unit 119 generates a sound conversion text based on the recommended merchandise item text. Here, the sound conversion text is instruction information for instructing the sound conversion LLM 143 to generate a text.

For example, the third generation unit 119 generates a sound conversion text to permit a natural or conversational description of the recommended merchandise item text when output as speech or the like.

Here, the template for generation of the instruction information can be stored in the memory unit 14 in advance. Note that a plurality of templates may be stored. In this case, the third generation unit 119 may select among the plurality of templates differently depending on the situation. For example, the third generation unit 119 may switch the template according to a keyword contained in the sound conversion text (e.g., a word such as male, female, or the like).

In an embodiment, the instruction content of the sound conversion text includes to add aspects related customer information (e.g., the current position, the appearance feature, the merchandise items purchased in the past, or the like of the customer) to the recommended merchandise item text.

Specifically, the third generation unit 119 adds text data containing the description of the customer position information, the description of the customer feature information, and the description of the customer personal information to the sound conversion text.

As an example, the third generation unit 119 adds text data describing “MS. A LOOKING AROUND LINGERIE SECTION” or the like as the description of the customer position information to the sound conversion text based on the customer personal information and the customer position information sent out from the determination unit 117.

Further, the third generation unit 119 adds text data describing “MS. A WEARING WHITE SWEATER OF B BRAND” or the like as the description of the customer feature information to the sound conversion text based on the customer personal information and the customer feature information sent out from the determination unit 117.

Furthermore, the third generation unit 119 adds text data describing “MS. A PURCHASED SHIRT WITH MERCHANDISE ITEM CODE XX ON MM/DD” or the like as the description of the customer personal information to the sound conversion text based on the customer personal information sent out from the determination unit 117.

Note that the instruction content of the sound conversion text may contain content for instructing to designate an output sequence of the respective elements contained in the recommended merchandise item (e. g., text sequence of a presentations when there are plurality of recommended merchandise items or the like) and summarize and output the content of the recommended merchandise item text.

The third generation unit 119 correlates the generated sound conversion text with the sound output apparatus information and sends out the information to the fourth generation unit 120.

Next, the fourth generation unit 120 of the LLM processing section 102 is explained. The fourth generation unit 120 generates a promotion sound text. The fourth generation unit 120 is an example of the third generation unit. The promotion sound text is a text (script) regarding a recommended merchandise item that does not cause a feeling of strangeness when spoken (output as sound).

For example, the fourth generation unit 120 inputs the sound conversion text from the third generation unit 119 to the sound conversion LLM 143 stored in the memory unit 14. The fourth generation unit 120 acquires the text data output from the sound conversion LLM 143 as a promotion sound text.

The fourth generation unit 120 correlates the generated promotion sound text with the sound output apparatus information and sends out the information to the fifth generation unit 121.

Next, the fifth generation unit 121 of the LLM post-processing section 103 is explained. The fifth generation unit 121 generates promotion sound. The fifth generation unit 121 is an example of the third generation unit. For example, the fifth generation unit 121 converts the promotion sound text from the fourth generation unit 120 into sound data and generates promotion sound by a known technique of converting text into sound.

Further, the fifth generation unit 121 correlates the generated promotion sound with the sound output apparatus information and sends the information to the output control unit 122.

Note that the fifth generation unit 121 may execute part or all of the above described processing of the fourth generation unit 120. Further, the fourth generation unit 120 may execute part or all of the processing of the fifth generation unit 121.

The output control unit 122 outputs promotion information.

For example, the output control unit 122 transmits the promotion image to the image display apparatus 2 via the communication line 7. The image display apparatus 2 displays the received promotion image.

The output control unit 122 transmits the promotion sound to the sound output apparatus 3 via the communication line 7. The sound output apparatus 3 outputs the received promotion sound.

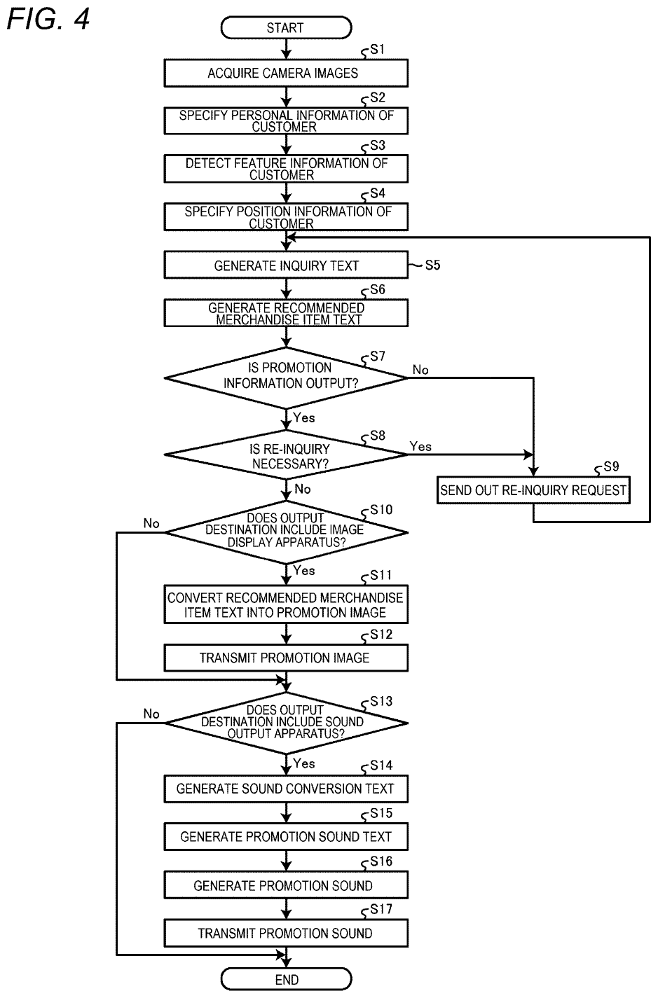

Next, processing executed by the SC 1 will be explained using FIG. 4. FIG. 4 is a flowchart showing an example of the processing executed by the SC 1.

First, the acquisition unit 111 acquires camera images (STEP S1). Here, the acquisition unit 111 acquires the camera images by receiving camera images from cameras 4 in real time via the communication line 7.

Note that, in FIG. 4, the processing of acquiring the camera images is described as STEP S1, however, the processing of acquiring the camera images can be continuously performed.

Then, the first specification unit 112 specifies customer personal information (STEP S2). For example, the first specification unit 112 extracts a customer face image using a known image recognition technique from one or more camera images acquired in STEP S1. The first specification unit 112 identifies personal information corresponding to the extracted face image by reference to the personal information DB 144.

Note that, in FIG. 4, the processing of specifying the customer personal information is described as STEP S2, however, the processing of identifying the customer personal information can be continuously performed.

Then, the detection unit 113 detects customer feature information (STEP S3). For example, the detection unit 113 specifies a customer corresponding to the face image extracted at STEP S2 from the customers appearing in the camera images acquired at STEP S1, and detects an appearance feature of the customer using a known image recognition technique.

Note that, in FIG. 4, the processing of detecting the customer feature information is described as STEP S3, however, the processing of detecting the customer feature information can be continuously performed.

Then, the second specification unit 114 specifies customer position information (STEP S4). For example, the second specification unit 114 receives a signal reception results of radio waves associated with a terminal ID of a portable terminal 6 via the communication line 7.

The second specification unit 114 identifies a position of the portable terminal 6 within the store based on the signal reception results for the terminal ID of the portable terminal 6 of the customer specified at STEP S2. The second specification unit 114 provides the specified position of the portable terminal 6 as customer position information.

Note that, in FIG. 4, the processing of specifying the customer position information is described as STEP S4, however, the processing of specifying the customer position information can be continuously performed.

Then, the first generation unit 115 generates an inquiry text (STEP S5). For example, the first generation unit 115 generates an inquiry text (prompt) regarding a merchandise item sold in the store with addition of description of the customer position information specified at STEP S2, description of the customer feature information detected at STEP S3, and description of the customer position information specified at STEP S4 as conditions.

Then, the second generation unit 116 generates a recommended merchandise item text (STEP S6). For example, the second generation unit 116 inputs the inquiry text generated at STEP S5 to the promotion LLM 142 stored in the memory unit 14. The second generation unit 116 acquires the text data output from the promotion LLM 142 as the recommended merchandise item text.

Then, the determination unit 117 determines whether or not promotion information is to be output (STEP S7).

For example, if the customer position information continuously specified at STEP S4 does not change over a predetermined time, the determination unit 117 determines that the promotion information is to be output. On the other hand, if the customer position information changes, the determination unit 117 determines that the promotion information is not to be output. If the unit determines that the promotion information is not to be output (STEP S7: No), the unit shifts to processing at STEP S9.

On the other hand, if the determination unit 117 determines that the promotion information is output (STEP S7: Yes), the unit determines whether or not a re-inquiry is necessary (STEP S8).

For example, the determination unit 117 compares the customer position information corresponding to the inquiry text generated at STEP S5 with the latest position information and, if the pieces of information are not the same, determines that a re-inquiry is necessary. On the other hand, if the pieces of information are the same, the determination unit 117 determines that a re-inquiry is unnecessary.

If the determination unit 117 determines that a re-inquiry is necessary (STEP S8: Yes), the unit sends out a re-inquiry request to the first generation unit 115 (STEP S9) and shifts to the processing at STEP S5. The first generation unit 115 received the re-inquiry request executes the processing at STEP S5 based on the latest customer personal information, feature information, and position acquired information in the continuously executed processing at STEPS S1 to S4.

On the other hand, if the determination unit 117 determines that a re-inquiry is unnecessary (STEP S8: No), the unit determines whether or not an output destination includes the image display apparatus 2 (STEP S10).

For example, if the image display apparatus 2 closest to the latest customer position information specified at STEP S4 is closer to the latest customer position information than the sound output apparatus 3 closest to the latest customer position information, the determination unit 117 determines that the output destination includes the image display apparatus 2.

Or, even when the sound output apparatus 3 is closer to the latest customer position information, if the image display apparatus 2 closest to the latest customer position information is located in a predetermined range of the latest customer position information, the determination unit 117 determines that the output destination includes the image display apparatus 2. If the output destination does not include the image display apparatus 2 (STEP S10: No), the unit shifts to processing at STEP S13.

On the other hand, if the output destination includes the image display apparatus 2 (STEP S10: Yes), the conversion unit 118 converts the recommended merchandise item text into a promotion image (STEP S11).

For example, the conversion unit 118 specifies a merchandise item image corresponding to a merchandise item name contained in the recommended merchandise item text with reference to the merchandise item image DB 146 stored in the memory unit 14. The conversion unit 118 converts the recommended merchandise item text into the specified merchandise item image and places the converted image according to the template, and thereby, generates a promotion image.

Then, the output control unit 122 transmits the promotion image to the image display apparatus 2 (STEP S12). For example, the output control unit 122 transmits the promotion image converted at STEP S11 to the image display apparatus 2 closest to the latest customer position information specified at STEP S4 via the communication line 7.

Then, the determination unit 117 determines whether or not an output destination includes the sound output apparatus 3 (STEP S13).

For example, if the sound output apparatus 3 closest to the latest customer position information specified at STEP S4 is closer to the latest customer position information than the image display apparatus 2 closest to the latest customer position information, the determination unit 117 determines that the output destination includes the sound output apparatus 3.

Or, even when the image display apparatus 2 is closer to the latest customer position information, if the sound output apparatus 3 closest to the latest customer position information is located in a predetermined range of the latest customer position information, the determination unit 117 determines that the output destination includes the sound output apparatus 3. If the output destination does not include the sound output apparatus 3 (STEP S13: No), the unit ends the processing.

On the other hand, if the output destination includes the sound output apparatus 3 (STEP S13: Yes), the third generation unit 119 generates a sound conversion text (STEP S14).

For example, the third generation unit 119 generates a sound conversion text for instructing to generate a text regarding a promotion of the merchandise item with addition of description based on the customer personal information, the customer feature information, and the customer position information corresponding to the merchandise item text generated at STEP S6 to the merchandise item text.

Then, the fourth generation unit 120 generates promotion sound text (STEP S15).

For example, the fourth generation unit 120 inputs the sound conversion text generated at STEP S15 to the sound conversion LLM 143 stored in the memory unit 14. The third generation unit 119 acquires the text data output from the sound conversion LLM 143 as a promotion sound text.

Then, the generation 121 generates fifth unit promotion sound (STEP S16). For example, the fifth generation unit 121 converts the promotion sound text generated (acquired) at STEP S15 into sound data and generates promotion sound by a known technique of converting text data into sound.

Then, the output control unit 122 transmits the promotion sound to the sound output apparatus 3 (STEP S17). For example, the output control unit 122 transmits the promotion sound generated at STEP S16 to the sound output apparatus 3 closest to the latest customer position information specified at STEP S4 via the communication line 7.

Note that, in FIG. 4, the processing at STEP S13 is after STEP S12, however, the processing at STEP S13 may be executed in parallel with STEP S10. Or, the processing at STEP S13 may be executed after the processing at STEP S8 and before STEP S10.

As described above, the SC 1 according to the embodiment acquires camera images from cameras provided in a facility, detects a feature of a customer appearing within the camera images, generates a recommended merchandise item text by inputting an inquiry text expressing the detected customer feature(s) to a promotion LLM 142 that outputs a text regarding a merchandise item sold in a store according the inquiry text (prompt) containing a personal feature, and outputs information based on the recommended merchandise item text.

Thereby, the SC 1 according to the embodiment may generate an inquiry text with addition of the detected customer features. The inquiry text is input to the promotion LLM 142 and a recommended merchandise item text is generated, and thereby, the recommended merchandise item text is more optimized for the customer. That is, according to the embodiment, the relevance of a promotion for a customer generated using generative AI may be increased.

Further, the SC 1 according to the embodiment generates an inquiry text with the addition of description of an appearance feature of a customer. Thereby, the SC 1 may generate a recommended merchandise item text better corresponding to a current mood or state of the customer (as estimated from current clothes or the facial expressions of the customer or the like) may be provided.

The SC 1 according to the embodiment identifies a customer from camera images, then retrieves a merchandise item purchase history of the customer from the personal information DB 144, and then generates an inquiry text with addition of description of the merchandise item purchase history. Thereby, the SC 1 according to the embodiment may suppress recommendations of a previously purchased merchandise item to the customer.

The SC 1 according to the embodiment identifies a customer position within the store, then merchandise items near the position to generate an inquiry text with addition of description of a nearby merchandise item to be promoted/recommended. Thereby, the SC 1 according to the embodiment may recommend purchase of a merchandise item near the current position of the customer in the store.

The SC according to the embodiment converts a recommended merchandise item text into a merchandise item image based on a merchandise item name and the merchandise item image DB 146 in which the merchandise item name and a merchandise item image are correlated, and then generates a promotion image containing the merchandise item image for output to the image display apparatus 2. Thereby, a customer may more easily understand a merchandise item being recommended for purchase. That is, the SC 1 may do a promotion in a way that helps the customer visually see and understand the recommended item.

The SC 1 according to the embodiment generates promotion sound for output by the sound output apparatus 3 by converting a recommended merchandise item text into a promotion sound text using the sound conversion LLM 143. The sound conversion LLM 143 may be optimized for converting the recommended merchandise item text into a promotion sound text that does not cause a customer a feeling of strangeness when the promotion sound text is converted into sound data. Thereby, a customer may understand a merchandise item being recommended to purchase even where an image of the merchandise item is hard to be seen by the customer. That is, the SC 1 according to the embodiment may do a promotion in a way that vocally appeals to the customer.

The SC 1 according to the embodiment outputs promotion information to an output apparatus when a change of customer position information within a predetermined time remains within a predetermined range. Here, a slight change (or no change) of the position information means that a customer pauses (dwells) at a position within a store. Pausing at one position often indicates that the customer has interest in something at the location. That is, the SC 1 according to the embodiment outputs promotion information relating to a position information when there is a slight change (no change) of the customer's position, and thereby, may avoid recommending purchase of a merchandise item for which the customer has low interest.

The SC 1 according to the embodiment outputs promotion information to an output apparatus (e.g., speaker or display screen) near the current position of a customer. Thereby, the SC 1 can avoid outputting promotion information in a way that does not reach the customer.

Note that the above described embodiments can be appropriately modified and implemented by changes made to configurations or functions of the SC 1. Accordingly, modified examples will be described below as other embodiments. Note that the following explanation will primarily focus on differences from the already described embodiments and explanation aspects common with those already described above may be omitted. The modified examples may be individually implemented or appropriately combined.

### Modified Example 1

In an embodiment, the SC 1 includes the promotion LLM 142 and the sound conversion LLM 143. In this modified example, a server apparatus other than the SC 1 includes the promotion LLM 142 and the sound conversion LLM 143.

In the modified example, a separate server apparatus including the promotion LLM 142 and the sound conversion LLM 143 is provided within the store along with the SC 1. Note that in some examples this separate server apparatus may be provided outside the store, however, it is preferable in such case that the other location be secured because information containing customer personal information is input to the promotion LLM 142 and the sound conversion LLM 143.

The second generation unit 116 of the modified example transmits an inquiry text from the first generation unit 115 to the other server apparatus via the communication line 7. The other server apparatus inputs the received inquiry text to the promotion LLM 142 and then transmits a recommended merchandise item text output from the promotion LLM 142 to the SC 1. The second generation unit 116 then sends the recommended merchandise item text to the determination unit 117.

In this modification, the fourth generation unit 120 transmits a sound conversion text (generated by the third generation unit 119) to the other server apparatus via the communication line 7. The other server apparatus inputs the received sound conversion text to the sound conversion LLM 143 and then transmits a promotion sound text output from the sound conversion LLM 143 to the SC 1. The fifth generation unit 121 converts the promotion sound text from the other server apparatus into promotion sound.

Note that, in the above description, a single server apparatus includes the promotion LLM 142 and the sound conversion LLM 143, however, different server apparatuses may provide the promotion LLM 142 and the sound conversion LLM 143.

According to this modified example, the processing load on the SC1 may be reduced.

### Modified Example 2

In an embodiment, the information processing system S includes both image display apparatuses 2 and sound output apparatuses 3. However, the information processing system S need include only one of the image display apparatus 2 or the sound output apparatus 3.

According to the modified example, a promotion for a customer may be done only by an output apparatus considered appropriate to the circumstances of the store.

### Modified Example 3

In an embodiment, the merchandise item purchase history of the customer is stored in the personal information DB 144 of the memory unit 14. In this modified example, the merchandise item purchase history of the customer is stored in the portable terminal 6.

In the modified example, the first specification unit 112 specifies the terminal ID of the portable terminal 6 of the customer from the personal information DB 144. The first specification unit 112 can acquire the merchandise item purchase history from a portable terminal 6 via the access point 5 and the communication line 7.

According to the modified example, an amount of information required to be stored in the personal information DB 144 of the memory unit 14 of the SC 1 may be reduced.

### Modified Example 4

In an embodiment, the SC 1 converts the recommended merchandise item text into image data or sound data and outputs the converted data, however, the SC 1 may output the recommended merchandise item text as text data to the display device, which may either convert the text data to visual images or simply display the text.

According to the modified example, a recommended merchandise item text may be displayed on a simplified display device that can display only text characters, and a promotion of a merchandise item may be done at low cost.

Note that a program executed by the SC 1 can be recorded and provided embodied in a computer-readable recording medium such as a CD-ROM, a flexible disk (FD), a CDR, or a DVD (Digital Versatile Disk) in an installable or executable format.

A program to be executed by the SC may be stored in a computer connected to a network, such as the Internet, and downloaded and provided via the network. Such a program may be also or instead provided or distributed via a network such as the Internet.

A program executed by the SC 1 may be incorporated in the ROM 12 or the like in advance.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing apparatus, comprising:
a camera interface connectable to a camera to receive camera images captured by the camera; and
a processor configured to:
detect a feature of a customer of a store within a camera image;
generate first text information indicating the detected feature of the customer;
input an inquiry text with the first text information added to a generative AI to generate second text information for a promotion of a merchandise item; and
output the second text information to an output device in the store, wherein
the generative AI generates the second text information based on items sold in the store.

2. The information processing apparatus according to claim 1, wherein the feature of the customer is a facial expression of the customer.

3. The information processing apparatus according to the claim 1, wherein the feature of the customer includes a color of clothing worn by the customer.

4. The information processing apparatus according to claim 1, wherein the processor is further configured to recognize the customer in the camera image using a facial recognition and acquire customer personal information based on the facial recognition.

5. The information processing apparatus according to claim 4, wherein at least a portion of the customer personal information is added to the inquiry text before input to the generative AI.

6. The information processing apparatus according to claim 4, wherein the customer personal information includes a purchase history of the customer.

7. The information processing apparatus according to claim 6, wherein the purchase history is acquired from a local database.

8. The information processing apparatus according to claim 6, wherein the purchase history is acquired from a portable terminal carried by the customer.

9. The information processing apparatus according to claim 1, wherein the processor is further configured to:
determine a position of the customer within the store;
compare the determined position to entries of a neighborhood merchandise item database; and
add description of a neighborhood merchandise to the inquiry text before input to the generative AI.

10. The information processing apparatus according to claim 1, wherein the processor is further configured to convert at least a portion of the second text information to an image before output to the output device.

11. The information processing apparatus according to claim 1, wherein the output device includes a display screen.

12. The information processing apparatus according to claim 1, wherein the second text information is converted to voice data for output to the output device.

13. The information processing apparatus according to claim 1, wherein the output device includes a speaker.

14. An information processing system for in-store promotional presentation, the system comprising:
a store server;
an output device in a store, the output device connected to the store server by a network;
a camera in the store connected to the store server by the network, the camera positioned to acquire camera images of a customer in the store; and
an network access point in the store to connect to a portable terminal of the customer, the network access point being connected to the store server by the network, wherein
the store server includes:
a processor configured to:
detect a feature of the customer within a camera image;
generate first text information indicating the detected feature of the customer;
input an inquiry text with the first text information added to a generative AI to generate second text information for a promotion of a merchandise item; and
output the second text information to the output device, wherein
the generative AI generates the second text information based on items sold in the store.

15. The information processing system according to claim 14, wherein the feature of the customer is a facial expression of the customer.

16. The information processing system according to claim 14, wherein the processor is further configured to recognize the customer in the camera image using a facial recognition and acquire customer personal information based on the facial recognition.

17. The information processing system according to claim 16, wherein at least a portion of the customer personal information is added to the inquiry text before input to the generative AI.

18. An information processing method by an information processing apparatus, comprising:
acquiring a camera image captured by a camera provided in a facility from the camera;
detecting feature of a customer appearing within the camera image;
generating first text information representing the feature of the customer based on the detected feature;
inputting an inquiry text incorporating the first text information to a generative AI to generate a second text information for a promotion of a merchandise item; and
outputting the second text information to an output device in the store, wherein
the generative AI generates the second text information based on items sold in the store.

19. The information processing method according to claim 18, wherein the feature of the customer is a facial expression of the customer.

20. The information processing method according to the claim 18, wherein the feature of the customer includes a color of clothing worn by the customer.
